(19) United States
(12) Patent Application Publication
(10) Pub. No.: US 2008/0137135 A1
(43) Pub. Date: Jun. 12, 2008

(54) PRINT CONTROL APPARATUS AND CONTROL METHOD THEREOF AND DEVICE DRIVER

(75) Inventor: Hiroki Takeishi, Machida-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/943,272

(22) Filed: Nov. 20, 2007

(30) Foreign Application Priority Data
Dec. 11, 2006 (JP) 2006-333866

(51) Int. Cl. G06F 3/12

(52) U.S. Cl. 358/1.15

(57) ABSTRACT

A job controller allocates a resource to a plurality of PDL analyzers and, in a case where an out-of-resource condition occurs in any of the PDL analyzers while the PDL analyzers are performing PDL data analysis in parallel, causes a PDL analyzer to interrupt the processing being performed in parallel with processing by the other PDL analyzer, releases a resource corresponding to the interrupted processing, and reallocates the released resource to the other PDL analyzer to allow the other PDL analyzer to continue processing.

### BACKGROUND OF THE INVENTION

1. Field of the Invention

The present invention relates to a print control apparatus that performs analysis of a page description language and rendering, a control method thereof, and a device driver.

2. Description of the Related Art

Printing systems that print electronic documents are widely used and demand for color image printing using color printers is increasing in recent years. In these printing systems, a printer analyzes a page description language (PDL) sent from a host computer or a print server to generate raster image data and prints a color image on the basis of the raster image data. In such a printing process, typically a display list (DL), which is an intermediate language, is generated by analyzing PDL data and the DL is converted (rendered) to the raster image data.

As the capabilities of host computers have been sophisticated, the number of color electronic documents to be printed has increased and the host computers have become capable of handling high-resolution color image data and graphic data. Many host computers are connected with color printers through networks, and there has been a growing demand for printing more documents on color printers at high speeds with high resolutions. In order to meet the demand for printing such high-resolution documents quickly, PDL data sent from a host computer must be analyzed at high speed. One way to enable high-speed analysis of PDL data is to provide multiple central processing units (CPUs) for PDL data processing in a printer. For example, there is a system in which a color printer has multiple CPUs and a process is distributed among the CPUs, thereby achieving fast PDL data processing. CPUs in which multiple CPU cores are mounted on a single silicon die are also becoming widespread in these years and color printers containing such fast CPUs have been implemented.

On the other hand, software technologies that make it possible to make full use of the capabilities of CPUs of these types are also required. The hardware capacities of multiple CPU cores available cannot fully be utilized unless data is provided in so that blocks of a process provided to CPU cores can be performed in parallel. One software technique that makes full use of such a CPU implementation that includes multiple cores or multiple CPUs is multitasking. Multitasking is a method in which multiple tasks are performed in parallel or in virtually parallel. This method enables multiple CPU cores to perform parallel processing, thereby making full use of their hardware capacities. Under these circumstances, a mode is becoming popular in these days in which a host computer has a hardware component including multiple CPU cores and multitasked software runs on the hardware component.

[Description of Fallback]

Conventional printers and printer controllers that process a page description language (PDL) analyze data described in a PDL (PDL data or image description data) to generate a display list (DL), which is an intermediate language. They then typically generate (render) raster image data from the DL. The rendering in this process sequence places a very heavy load processing. Therefore, hardware dedicated to rendering (RIP: raster image processor) is typically provided. However, provision of the hardware enables access only to a pre-limited memory space. Therefore, there is the constraint that the entire DL of a region (usually one page) to be rendered must be contained in the limited memory space.

In order to avoid this constraint, processing called fallback has been performed. To facilitate understanding of fallback processing, a flow of process in which fallback processing is not performed will be described first and then a process flow in which fallback is performed will be described.

FIG. 10 is a diagram illustrating a flow of process performed by a typical job controller, PDL analyzer, and RIP. When the job controller receives a given amount of PDL data, the job controller passes the PDL data to the PDL analyzer and instructs the PDL analyzer to initiate analysis of the PDL data. In response to the instruction, the PDL analyzer starts to analyze the PDL data. When the PDL analyzer completes the analysis of the PDL data, the PDL analyzer responds by a PDL analysis completion notice. When the PDL analyzer runs out of memory space for storing intermediate data during the analysis, the PDL analyzer notifies the job controller of the out-of-memory condition. In response to this, the job controller instructs the PDL analyzer to interrupt the PDL analysis. When the out-of-memory condition is resolved, the job controller instructs the PDL analyzer to resume PDL analysis. After completion of the PDL data analysis, the job controller instructs the RIP to start rendering (start RIP rendering). In response to this, the RIP starts rendering. After completion of the rendering, the RIP notifies the job controller of the completion of rendering (RIP rendering completion).

The process is shown in FIGS. 11A to 11C along with a data flow.

FIGS. 11A to 11C are diagrams illustrating a flow of data among the job controller, the PDL analyzer, and the RIP.

In FIGS. 11A to 11C, a memory area 1001 for storing PDL data stores PDL data 1007 in its limited memory space. PDL data 1007 received by the printer is passed to the job controller 1004 which controls the flow of process relating to the PDL data. Then, the job controller 1004 adds information required for processing the PDL data to the PDL data 1007 based on information received from an external information processing apparatus or setting information stored in the printer and sends it to the PDL analyzer 1005 (FIG. 11A).

The PDL analyzer 1005 analyzes the provided PDL data 1007 to generate a DL 1008, which is intermediate data that can be processed by the RIP 1006 (FIG. 11B). The RIP 1006 generates image data 109 from the DL 1008 (FIG. 11C). Here, the DL 1008 is written in an area having a limited capacity reserved for storing the DL. The image data 109 is written by the RIP 1006 in an area 1003 having a limited capacity. Thus, image data 1009 can be sent to a printer engine of the printer to produce a visible image.

However, the capacity of the memory area used in this process is finite whereas the amounts of memory used vary depending on the complexity and other factors of given PDL data 1007. That is, because the data size (volume) of PDL data 1007 is not limited, the data size of the DL 1008 generated from the PDL data 1007 can be huge. Furthermore, as the complexity of the DL 1008 increases and its data size increases accordingly, the RIP 1006 that renders the DL 1008 consumes a larger amount of work area. In such a case, the memory space of the area 1002 for storing the DL 1008 can run out.

One way to overcome the limitation is fallback. FIGS. 12A to 12C illustrate the fallback.

FIGS. 12A to 12C illustrate a process performed when the memory space of the area 1002 runs out in the process shown in FIGS. 11A to 11C.

When the data size of a DL 1008 exceeds the memory space 1002 accessible to the RIP 106, the fallback renders the DL 1008 generated up to that point of time into image data 1009 in FIG. 12A. Then DL 1008 generated up to the time point is deleted. The image data thus generated is added to the DL 1008 as a background image 1010 of the drawing area (FIG. 12B). Because the background image 1010 is typically compressed, the data size of the added DL is smaller than the capacity of the memory space 1002. Accordingly, the remaining DL can be stored in the released area of the memory area 1002 (FIG. 12C). In this way, a DL 1008 of a large data size can be processed using a limited capacity of the memory 1002. In addition, the work area of the RIP 1006 is also cleared on completion of the rendering in the fallback. Therefore, the size limitation of the work area can also be overcome and a low-cost printer can be provided. The fallback process illustrated above is described in Japanese Patent Laid-Open No. 07-137355, No. 2000-261632, and No. 2002-120414.

However, this multitasking has a problem that it consumes larger amounts of resources such as memory. On the other hand, batch processing that processes data in sequence, one set of data at a time, consumes only a limited amount of memory required for one task. Multitasking requires a larger amount of memory than batch processing because all or at least part of data involved in multiple tasks must be loaded into the memory.

As has been stated above, the capacity of a memory area of a printer is limited and printing of images using multitasking consumes a large amount of memory and therefore increases the probability of occurrence of fallback described above. That is, the related-art technique described above requires time for rendering a DL up to halfway to generate a background image when fallback is performed. In addition, time for compressing the background image and decompressing the compressed image is required. Consequently, the amount of processing time increases as compared with in a case that fallback does not occur. Thus, it is possible that the advantageous functionality of multitasking introduced is underutilized.

While fallback has the advantage that an image can be printed with a limited memory capacity, the fallback increases processing time because compression and decompression of image data is required. Therefore, the multitasking advantage of faster dual core processing cannot fully be utilized. Consequently, the demand for fast printing of electronic documents stated earlier cannot be met.

Typically, a technique commonly called lossy (non-reversible) compression, which degrades image quality, is used for compressing and decompressing image data. Therefore, in a case where a fallback occurs, the quality of an image degrades, and the demand for printing color electronic documents stated earlier with high resolutions cannot be met.

### SUMMARY OF THE INVENTION

An aspect of the present invention is to eliminate the problems set forth above.

A feature of the present invention is to provide a print control apparatus and a control method thereof, and a device driver, capable of preventing reduction in efficiency of image data generation due to insufficient resources in multitasking.

According to an aspect of the present invention, there is provided a print control apparatus comprising: an input unit configured to input page description language data; a plurality of drawing units, each of which configured to perform a processing for analyzing the page description language data input by the input unit to generate image data; a control unit configured to control resource allocation to the plurality of drawing units and parallel processing performed by the plurality of drawing units; and an interruption unit configured to interrupt a processing performed by a first drawing unit of the plurality of drawing units that are performing the parallel processing in a case where an out-of-resource condition occurs in any of the drawing units during the parallel processing; wherein the control unit, in response to that the interruption unit interrupts the processing performed by the first drawing unit, releases a resource associated with an interrupted processing and allocates released resource to another drawing unit to allow the another drawing unit to continue processing.

According to another aspect of the present invention, there is provided a control method of a print control apparatus for performing a process for converting page description language data into image data in a multitasking manner, the method comprising the steps of: inputting page description language data; controlling resource allocation to a plurality of drawing tasks each of which analyzes page description language data input in the inputting step to generate image data and parallel processing performed by the plurality of drawing tasks; and interrupting a processing performed by a first drawing task of the plurality of drawing tasks that are performing the parallel processing in a case where an out-of-resource condition occurs in any of the drawing tasks during the parallel processing; wherein in the controlling step, in response to that the interrupting a processing performed by the first drawing task, a resource associated with the interrupted processing is released and the released resource is allocated to another drawing task to allow the another drawing task to continue processing.

According to another aspect of the present invention, there is provided a device driver for performing a process for converting page description language data into image data in a multitasking manner, the device comprising: an input unit configured to input page description language data; a plurality of drawing units each of which configured to analyze the page description language data input by the input unit to generate image data; a control unit configured to control resource allocation to the plurality of drawing units and parallel processing performed by the plurality of drawing units; and an interruption unit configured to interrupt a processing performed by a first drawing unit of the plurality of drawing units that are performing the parallel processing in a case where an out-of-resource condition occurs in any of the drawing units during the parallel processing; wherein the control unit, in response to that the interruption unit interrupts the processing performed by the first drawing unit, releases a resource associated with interrupted processing and allocates released resource to another drawing unit to allow the another drawing unit to continue processing.

Further features and aspects of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate an embodiment of the invention and, together with the description, serve to explain the principles of the invention.

FIG. 1 is a block diagram mainly showing a configuration of an image forming apparatus (laser printer) according to an exemplary embodiment of the present invention;

FIG. 2 depicts a schematic cross-sectional view schematically showing a mechanism of the laser printer according to the exemplary embodiment;

FIG. 3 is a block diagram showing a configuration of a printer controller of the laser printer according to the present exemplary embodiment;

FIG. 4 is a flow diagram explaining a processing flow of data in the printer controller according to the present exemplary embodiment, on a functional block basis;

FIG. 5 is a diagram illustrating a software configuration of a job controller, a PDL analyzer, and an RIP in which multitasking according to the present exemplary embodiment is enabled;

FIG. 6 is a diagram illustrating a flow of process performed by the job controller, PDL analyzer, and RIP according to the present exemplary embodiment;

FIGS. 7A to 7F are diagrams illustrating a data flow in PDL analyzing processing according to the exemplary embodiment implemented by multitasking;

FIG. 8 is a diagram illustrating a process performed by the job controller, PDL analyzer, and RIP according to the present exemplary embodiment;

FIG. 9 is a flowchart explaining how the job controller according to the present exemplary embodiment determines which of multiple rules is to be used to choose a PDL analyzer to be disabled;

FIG. 10 is a conceptual diagram of modules of a program that implements rendering by multitasking;

FIGS. 11A to 11C are diagrams illustrating a conventional PDL process and rendering process; and

FIGS. 12A to 12C are diagrams illustrating fallback processing in the conventional PDL process and rendering process.

### DESCRIPTION OF THE EMBODIMENTS

Preferred exemplary embodiments of the present invention will be described below in detail with reference to the accompanying drawings. The following exemplary embodiments are not intended to limit the claims of the present invention and not all combinations of the features described in the exemplary embodiments are essential to the solving means of the present invention.

An exemplary configuration of a laser printer, which is one example of an image forming apparatus including a print control apparatus to which exemplary embodiments of the present invention can be applied will be described first. The present exemplary embodiments are also applicable to other types of output apparatuses such as inkjet printers, MFPs (Multi Function Peripherals), image setters, offset printing machines, in addition to laser printers.

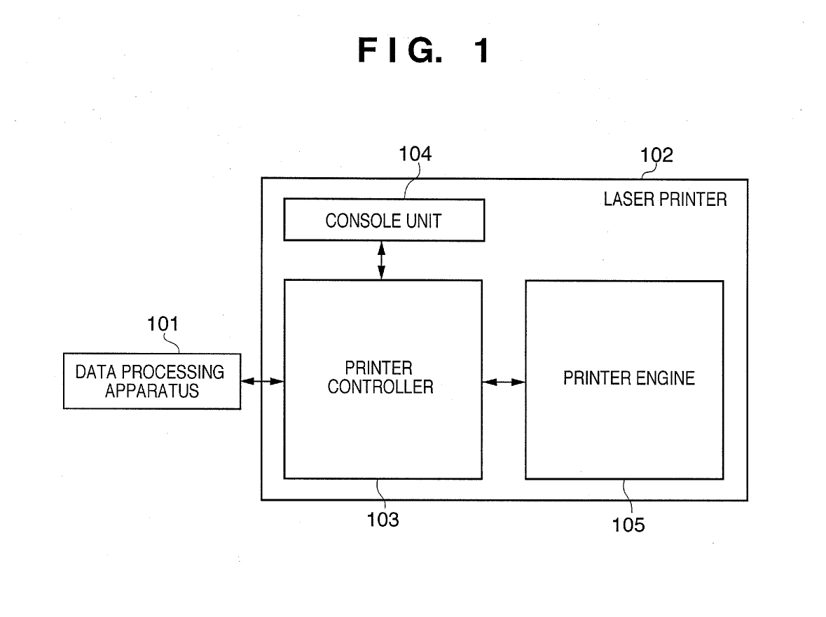

FIG. 1 is a block diagram mainly showing the configuration of an image forming apparatus (laser printer) 102 according to an exemplary embodiment of the present invention.

In FIG. 1, a data processing apparatus 101, which may be a computer such as a personal computer, functions as a source of image information or a controller of a printer. In the exemplary embodiment, the image forming apparatus 102 is a laser printer (printer). A printer controller 103, which is one example of a print control apparatus generates bitmap data based on image information (such as an ESC code or a page description language) provided from the data processing apparatus 101, on a page-by-page basis, and sends the bitmap data to a printer engine 105. The printer engine 105 forms an electrostatic latent image on a photosensitive drum based on the bitmap data provided from the printer controller 103 and transfers and fixes the electrostatic latent image on a recording medium to print an image (electrophotographic printing). A console unit 104 is used as a user interface. A user can operate the console unit 104 to instruct the printer 102 to perform a desired operation. Information about processing by the printer 102 and alerts to the user are displayed on the console unit 104.

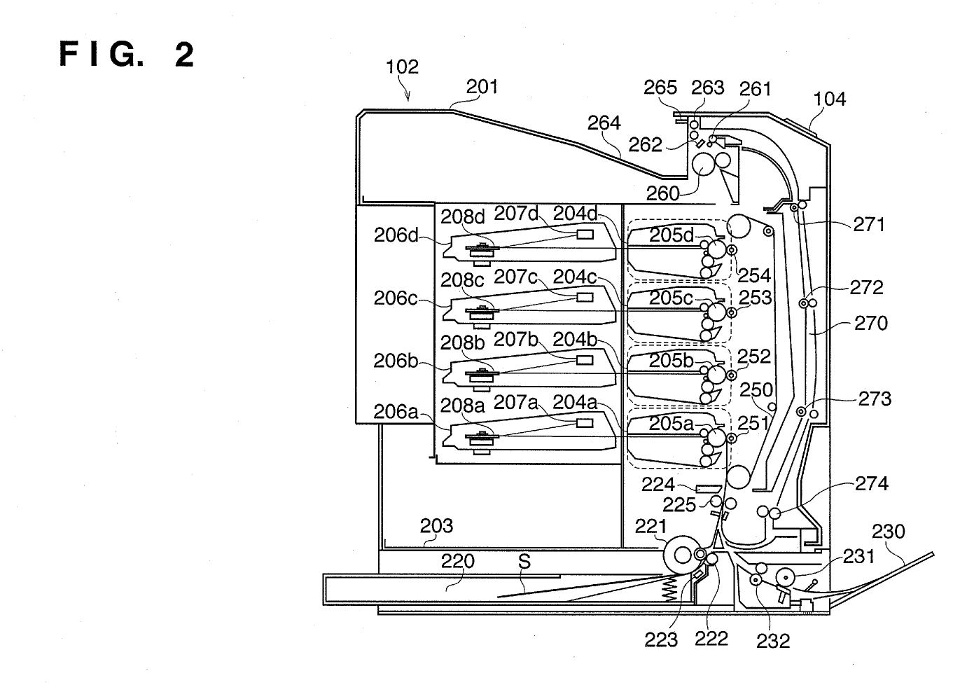

FIG. 2 depicts a schematic cross-sectional view schematically showing a mechanism of a laser printer 102 according to the exemplary embodiment of the present invention. A cross-sectional view illustrating a configuration of a tandem color printer 102 is shown here.

In FIG. 2, reference numeral 201 denotes a printer chassis. The console unit 104 includes components such as switches used by a user for providing commands and a display for displaying information such as settings of the printer and messages to the user. Reference numeral 203 denotes a board deck containing boards (such as circuit boards) constituting electronic circuits of the printer controller 103 and the printer engine 105.

A paper cassette 220 holds multiple paper sheets (recording medium) S and has a mechanism for electrically sensing the size of a paper sheet by using a partition plate, not shown. A cassette clutch 221 includes a cam that picks up one paper sheet S at the top of a stack of paper sheets S loaded in the paper cassette 220 and conveys the sheet S picked up to a feeding roller 222 by a drive force transmitted from a driving motor (not shown). The cam rotates intermittently each time paper is fed and conveys one paper sheet S at one rotation. A paper detection sensor 223 detects an amount of papers S held in the paper cassette 220. The feeding roller 222 conveys the paper sheet S so that a leading edge of the paper sheet S reaches a resist shutter 224. The resist shutter 224 can depress the paper sheet S to stop paper feeding.

Reference numeral 230 denotes a manual feed tray and reference numeral 231 denotes a manual feed clutch. The manual feed clutch 231 is used for conveying a paper sheet S so that a leading edge of the paper sheet S reaches a manual feeding roller 232. The manual feeding roller 232 is used for conveying a paper sheet S so that the leading edge of the paper sheet S reaches the resist shutter 224. Paper sheets S used for printing images are supplied from one of the paper cassette 220 and the manual feed tray 230.

The printer engine 105 communicates with the printer controller 103 in accordance with a given communication protocol and selects one of the paper cassette 220 and the manual feed tray 230 in accordance with a command from the printer controller 103. In response to a print start command, the printer engine 105 conveys a paper sheet S from the selected paper cassette 220 or the manual feed tray 230 to the resist shutter 224. The printer engine 105 includes paper feeding mechanisms relating to electrophotographic printing process such as latent image formation, transfer, and fixing, paper ejection mechanisms and the like.

Reference numerals 204a, 204b, 204c, and 204d denote image forming units having photosensitive drums 205a, 205b, 205c, and 205d and a toner reservoir and generating a toner image on a paper sheet S by electrophotographic process. Reference numerals 206a, 206b, 206c, and 206d denote laser scanners, each providing image information scanned by a laser beam to their associated image forming units. A paper conveying belt 250 for conveying a paper sheet S is stretched flat by multiple rollers 251 to 254 in the paper conveying direction (direction from the bottom to the top of FIG. 2) in the image forming units 204a, 204b, 204c, and 204d. At the upstream in the conveying direction by the paper conveying belt 250, a paper sheet S is electrostatically absorbed to the paper conveying belt 250 by an absorptive roller 225 to which bias is applied. The four photosensitive drums 205a, 205b, 205c, and 205d are disposed in line in such a manner that they face the conveying surface of the belt 250. Provided in each of the image forming units 204a, 204b, 204c, and 204d is an electric charger and a developer which surround near the rim of each photosensitive drum.

Reference numerals 207a, 207b, 207c, and 207d in the laser scanners 206a, 206b, 206c, and 206d denote laser units. A semiconductor laser of each laser unit is driven in accordance with an image signal (/VIDEO signal) sent from the printer controller 103 and emits a laser beam. The laser beam emitted from each laser unit is scanned by a polygon mirror (rotating polygonal mirror) 208a, 208b, 208c, and 208d associated with the laser unit to form an electrostatic latent image on its associated photosensitive drum.

A fixing unit 260 fixes by heat a toner image transferred onto a paper sheet S by the image forming units 204a to 204d. A conveying roller 261 conveys a paper sheet S to discharge the paper sheet. A discharged paper sensor 262 detects discharge of a paper sheet S. A feeding path changeover roller 263, which functions as both discharging roller and double-sided printing roller, conveys a paper sheet S in the discharge direction and, if a sheet S conveyance command is issued, discharges the paper sheet S directly to a discharge tray 264. On the other hand, if the conveyance command is double-sided printing convey, the feeding path changeover roller 263 changes the rotation direction of the roller 263 to switch back in the opposite direction immediately after the back-end of the paper sheet S passes through the discharged paper sensor 262, thereby conveying the paper sheet S to a feeding path for double-sided printing 270. A discharged paper amount sensor 265 detects an amount of papers loaded on the discharge tray 264.

A paper sheet S for double-sided printing is conveyed to the feeding path for double-sided printing 270 by the feeding path changeover roller 263 which functions as both discharging roller and double-sided printing roller. In the feeding path 270, the paper sheet S is returned by the rotation of double-sided conveyance rollers 271 to 274 to the resist shutter 224, where the paper sheet S waits for a command to be conveyed to the image forming units 204a, 204b, 204c, and 204d. The printer 102 can further include an optional unit such as an optional cassette and a feeder of an envelope.

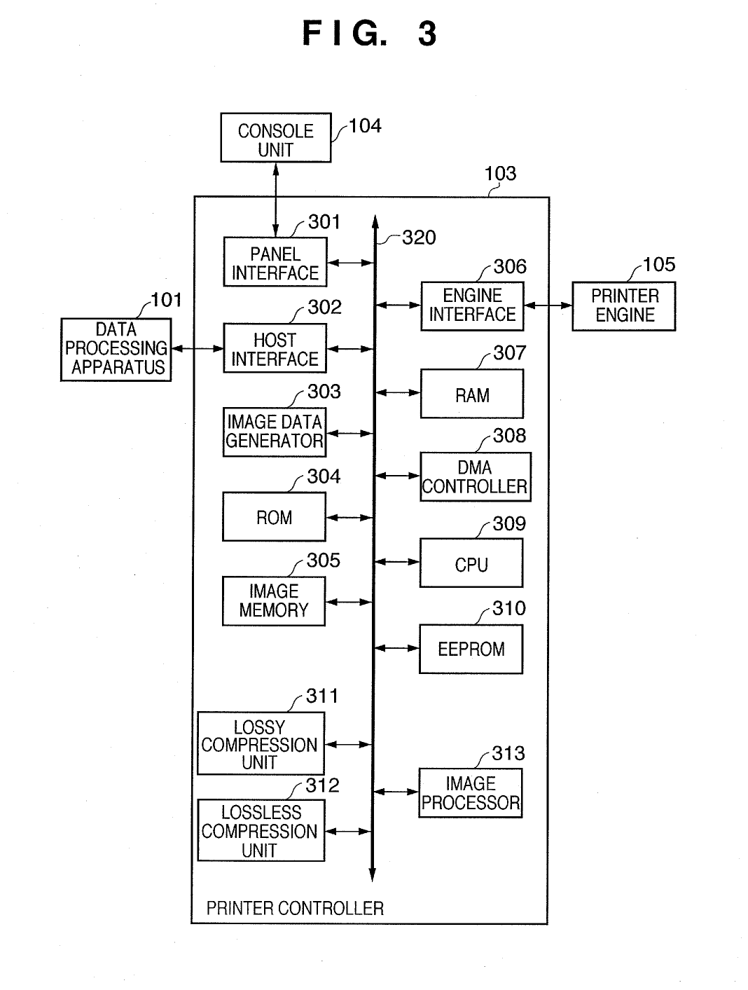

FIG. 3 is a block diagram showing a configuration of the printer controller 103 constituting the print control apparatus of the laser printer 102 according to the present exemplary embodiment.

A host interface 302 has an input buffer (not shown) for inputting PDL data sent from the data processing apparatus 101 and settings for instructing an operation of the printer 102. The host interface 302 also includes an output buffer (not shown) for temporarily holding data to be sent to the data processing apparatus 101 and output data including device information concerning the printer 102. The host interface 302 functions as an input/output unit for transmitting/receiving signals and packets to/from the data processing apparatus 101 and controls communications with the data processing apparatus 101. PDL data input through the host interface 302 is provided to an image data generator 303. The image data generator 303 analyzes the input PDL data and generates a drawing object, which is an intermediate language (DL), from the result of the analysis. The image data generator 303 also generates bitmap image data (raster image data) that can be processed by the printer engine 105. In particular, the image data generator 303 analyzes the PDL data and generates object information based on the analysis and performs rasterization process in parallel with the generation of the object information. In the rasterization process, display colors RGB (additive process) contained in the PDL data are converted into YMCK (subtractive process) that can be processed by the printer engine 105. Also, character codes contained in the PDL data are converted into font data such as bit patterns and outline fonts to generate bitmap image data on a page-by-page basis or band-by-band basis. Pseudo halftone processing is further applied to the bitmap image data by using a dither pattern to generate raster image data to which print processing can be performed by the printer engine 105. The unit that performs the process sequence from the processing of analyzing the PDL data to conversion to the raster image data is sometimes referred to as a drawing unit herein. The generated raster image data is stored in an image memory 305. Reading raster image data stored in the image memory 305 is controlled by a DMA controller 308. Control by the DMA controller 308 of reading raster image data from the image memory 305 is commenced by an instruction from a CPU 309.

The raster image data read from the image memory 305 is transferred to the printer engine 105 through an engine interface 306 as a video signal. The engine interface 306 has an output buffer (not shown) which temporarily holds the raster image data to be transferred to the printer engine 105 and an input buffer (not shown) which temporarily holds data sent from the printer engine 105. The engine interface 306 constitutes an input/output unit for transmitting/receiving signals to/from the printer engine 105 and controls communications with the printer engine 105.

A command concerning a mode setting or other command issued by a user through an input operation on the console unit 104 is input through a panel interface 301. The panel interface 301 constitutes an interface between the console unit 104 and the CPU 309. A command such as a mode setting command issued through an input operation on the console unit 104 to the printer 102 can also be provided through the host interface 302 which provides two-way communication with the data processing apparatus 101.

The CPU 309 controls the blocks described above in accordance with a mode specified from the console unit 104 or the data processing apparatus 101. The control is performed based on control programs stored in a ROM 304. The control programs stored in the ROM 304 include an OS (operating system) that performs time-shared control of a load module called a task as a unit in accordance with a system clock, and multiple load modules executed and controlled by the OS as functional units. The control programs including the load modules are stored in an EEPROM (non-volatile memory) 310 as required. A RAM 307 is used as a working area for a control by the CPU 309. The RAM 307 is configured in such a manner that its memory capacity can be expanded by an optional RAM connected to an expansion port, not shown. An image output buffer (not shown) is provided for the RAM 307 and used as a fallback buffer and an output buffer for holding the raster image data and attribute bits generated in processing by a RIP, which will be described later. Compressed image data stored in the output buffer is decompressed by the CPU 309 or a dedicated decompressor and is then transferred to the engine interface 306. These blocks, including the CPU 309, are connected onto a system bus 320. The system bus 320 includes an address bus and a control bus.

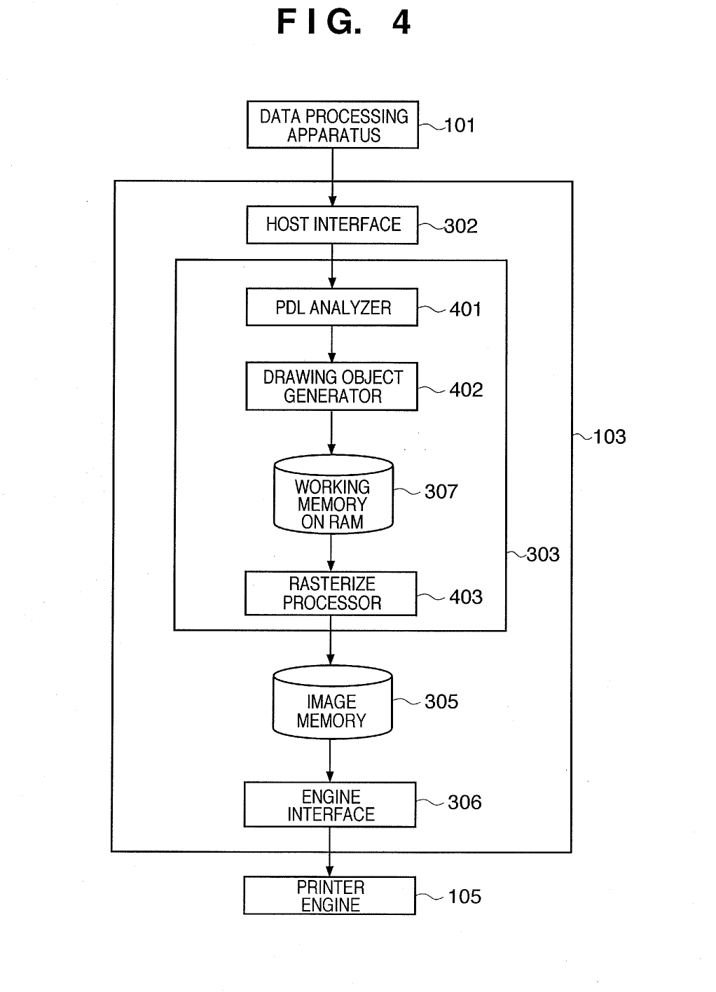

A lossy compression unit 311 applies lossy compression to the raster image data generated by a rasterize processor 403 (FIG. 4), which will be described later, and stores it in the output buffer described above of RAM 307. The lossy compression unit 311 according to the present exemplary embodiment uses JPEG. In JPEG, the compression ratio of image data to be compressed can be changed by making a change to a Q table used in compression. The quality of an image degrades as the compression ratio increases. While JPEG is used for the lossy compression herein, other lossy compression methods that can change compression ratios can be used in the present invention, of course. A lossless compression unit 312 applies lossless compression to attribute bits, which will be described later, and stores them in the output buffer. An image processor 313 applies image processing for character, image processing for image, image processing for graphics, image processing for color image, or image processing for monochrome image, or a combination of these to the raster image data based on the generated attribute bits.

FIG. 4 is a flow diagram explaining a processing path of data in the printer controller 103 according to the present exemplary embodiment, on a functional-block-by-block basis.

A command in the PDL data input from the data processing apparatus 101 through the host interface 302 is analyzed by a PDL analyzer 401. The result of the analysis is converted into a drawing object (intermediate language) in a drawing object generator 402 and temporarily stored in a working memory on the RAM 307. The rasterize processor 403 reads a drawing object from the working memory on the RAM 307 as required and performs rasterizing to generate bitmap image data. The bitmap image data to be ultimately printed on paper is rendered into raster image data and an attribute bit corresponding to each pixel is allocated to the pixel and these are stored in the image memory 305. The raster image data stored in the image memory 305 is output to the printer engine 105 through the engine interface 306 and an image is printed on a paper sheet S.

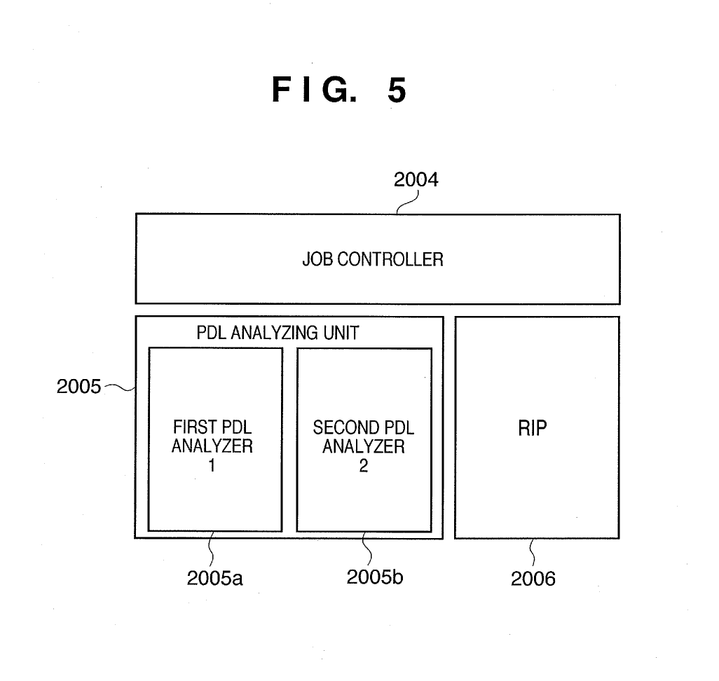

FIG. 5 is a diagram illustrating a software configuration of a job controller, PDL analyzing unit, and RIP in which multitasking is enabled according to the present exemplary embodiment.

Because multitasking is enabled, one job controller 2004, a PDL analyzing unit 2005 comprising two PDL analyzers 2005a and 2005b, and one RIP 2006 operate as shown in FIG. 5.

FIG. 6 is a diagram illustrating a sequence of process performed by the job controller, the PDL analyzing unit, and the RIP according to the exemplary embodiment.

PDL data input from the data processing apparatus 101 through the host interface 302 is first received at the job controller 2004. Multiple pieces of PDL data may be sent at a time in some cases. Analysis of a piece of PDL data is started before completion of analysis of the previous piece of PDL data using the two PDL analyzers 2005a and 2005b.

That is, the job controller 2004 issues a PDL analysis start command (1101a) to the PDL analyzer 2005a in order to cause it to analyze PDL data, based on information received from the data processing apparatus 101 or information such as setting information stored in the printer 102. Before receiving a completion notice (1103a) from the PDL analyzer 2005a, the job controller 2004 issues a PDL analysis start command (1101b) to the PDL analyzer 2005b similarly in order to cause it to process the next piece of PDL data.

In response to the command from the job controller 2004, the two PDL analyzers 2005a and 2005b analyze the PDL data to generate drawing objects (intermediate language) and temporarily store them in a working memory on the RAM 307 (1102a, 1102b). Upon completion of the processing by the PDL analyzers 2005a or 2005b, the PDL analyzer 2005a or 2005b notifies the job controller 2004 of the completion of the PDL processing (1103a, 1103b). In response to respective completion of the processing by the PDL analyzers, the job controller 2004 sequentially provides the data generated as drawing objects (intermediate language) and stored in the RAM 307 to the RIP 2006. Then the job controller 2004 respectively issues a rasterization (RIP) start command (1111a, 1111b) The RIP 2006 receives the command from the job controller 2004, reads a drawing object from the working memory on the RAM 307 for each task as required, and rasterize the drawing object. The RIP 2006 converts the drawing object into raster image data to be printed on paper sheet S and stores it in the image memory 305 (1112a, 1112b). Upon completion of the processing by the RIP 2006, the RIP 2006 notifies the job controller 2004 of the completion of the rasterization (1113a, 1113b). Upon reception of this completion notice from the RIP 2006, the job controller 2004 outputs the raster image data from the image memory 305 to the engine interface 306, and thus printing on the paper sheet S is started.

By the two PDL analyzers performing PDL analyzing tasks in parallel in this way, a hardware configuration having multiple CPU cores can be fully utilized and faster print processing of images can be implemented.

It will be understood that the present invention can be implemented even if the parallel processing described above is performed by a part of a PDL analyzing unit.

Also, the present invention can be implemented even if the parallel processing described above is performed by part or the whole of the job controller 2004.

While two PDL analyzing tasks are performed in parallel in the example given above, more than two PDL analyzing tasks may be performed in parallel.

An exemplary embodiment of the present invention will be described with respect to an image forming apparatus configured as described above.

### Exemplary Embodiment

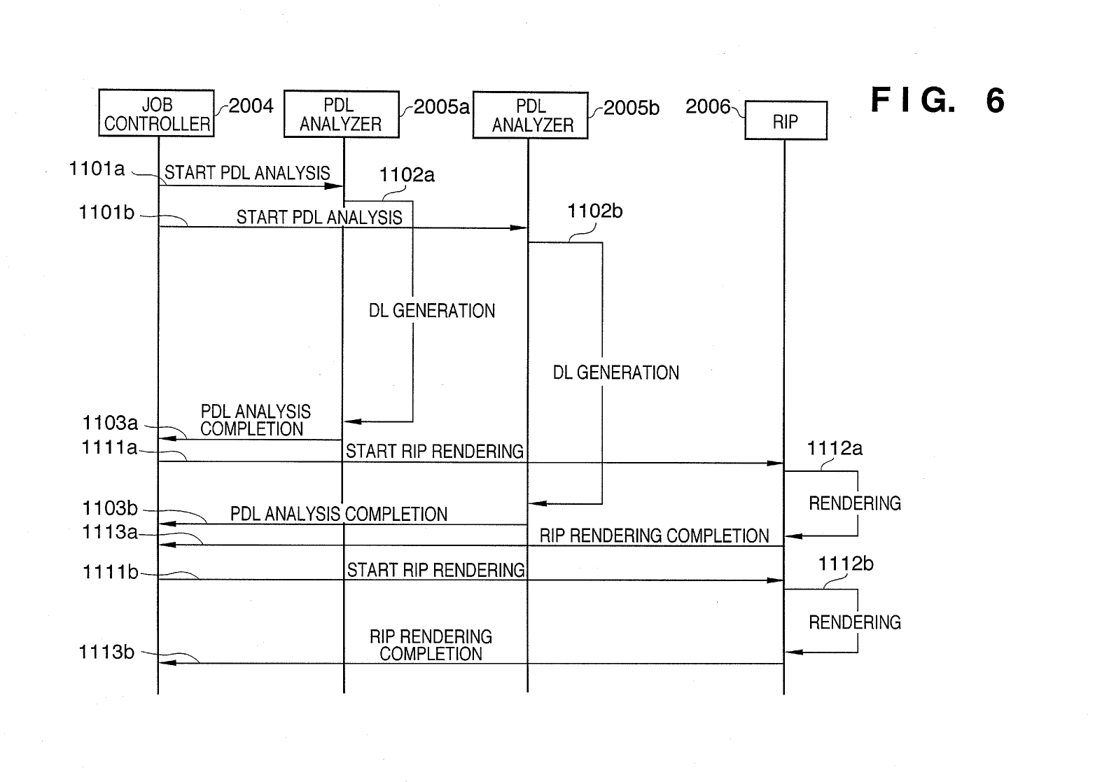

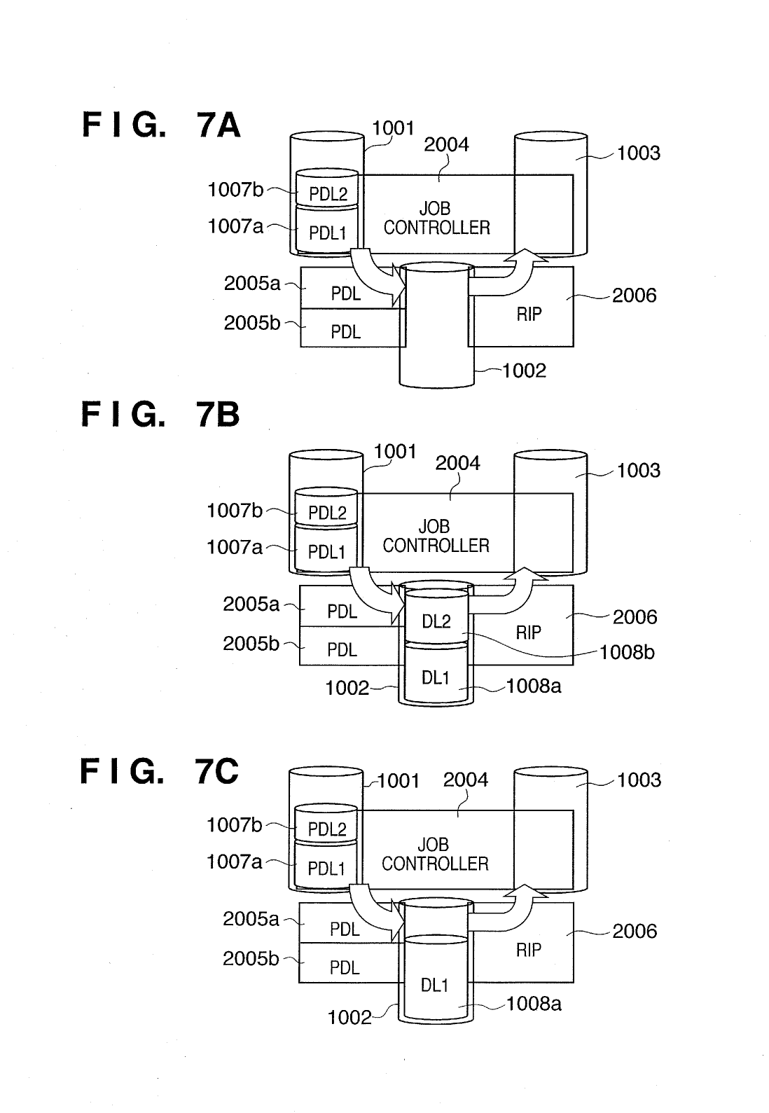

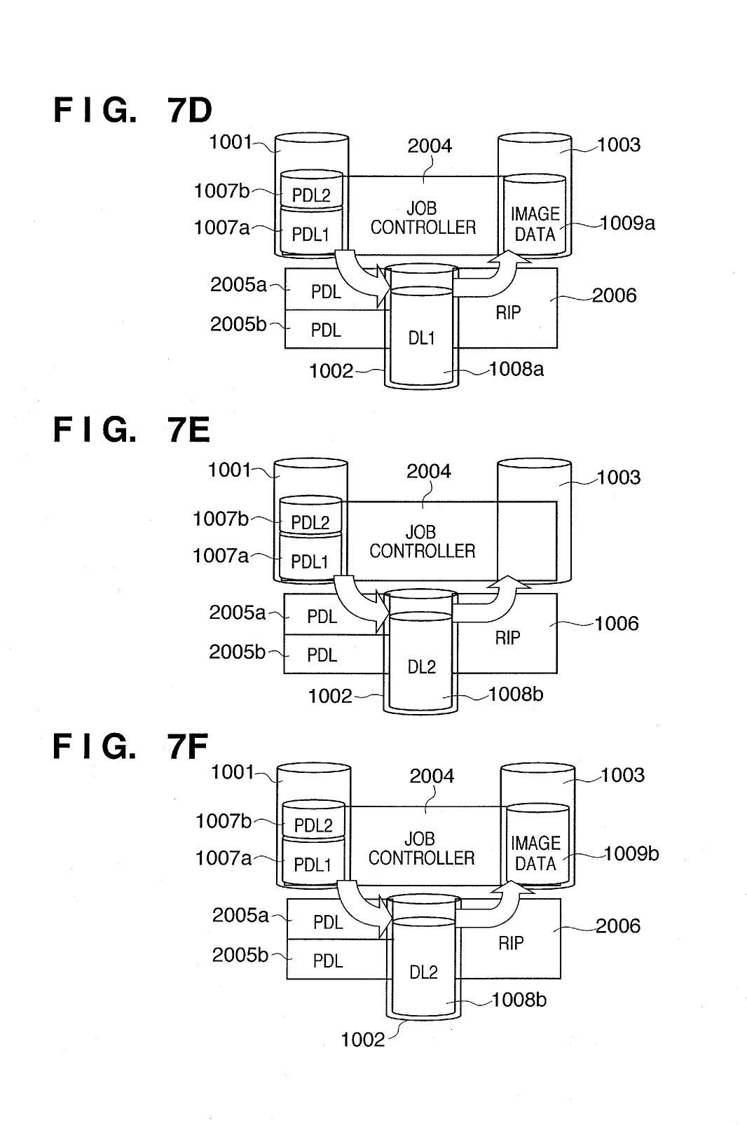

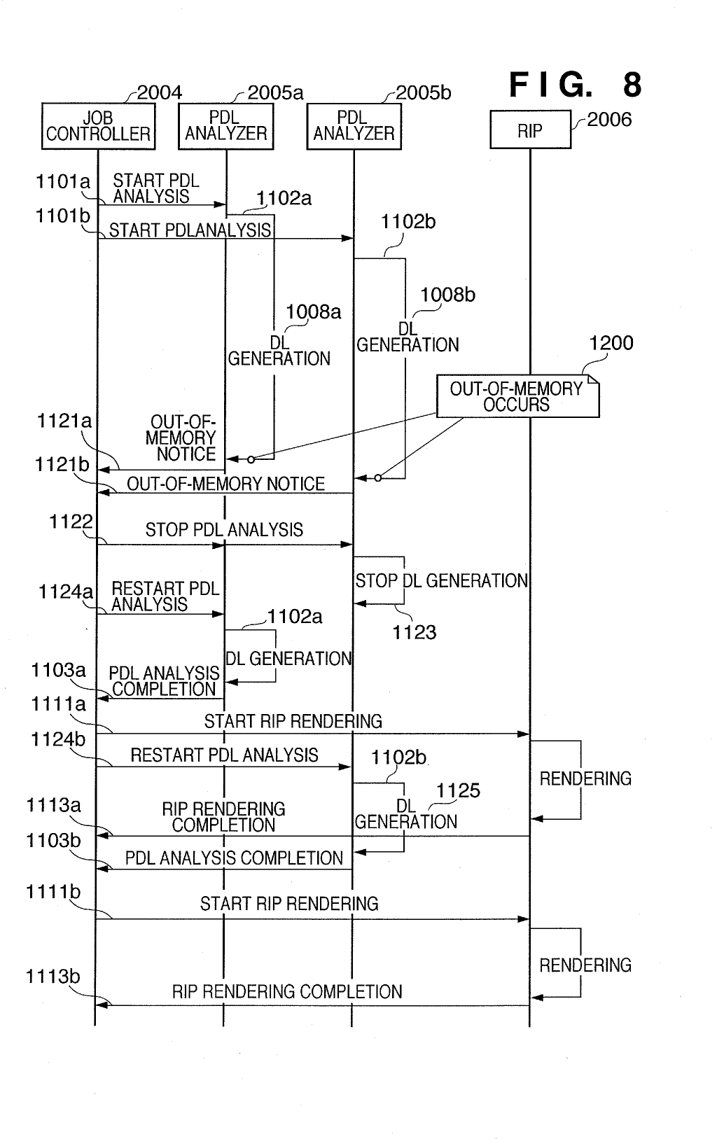

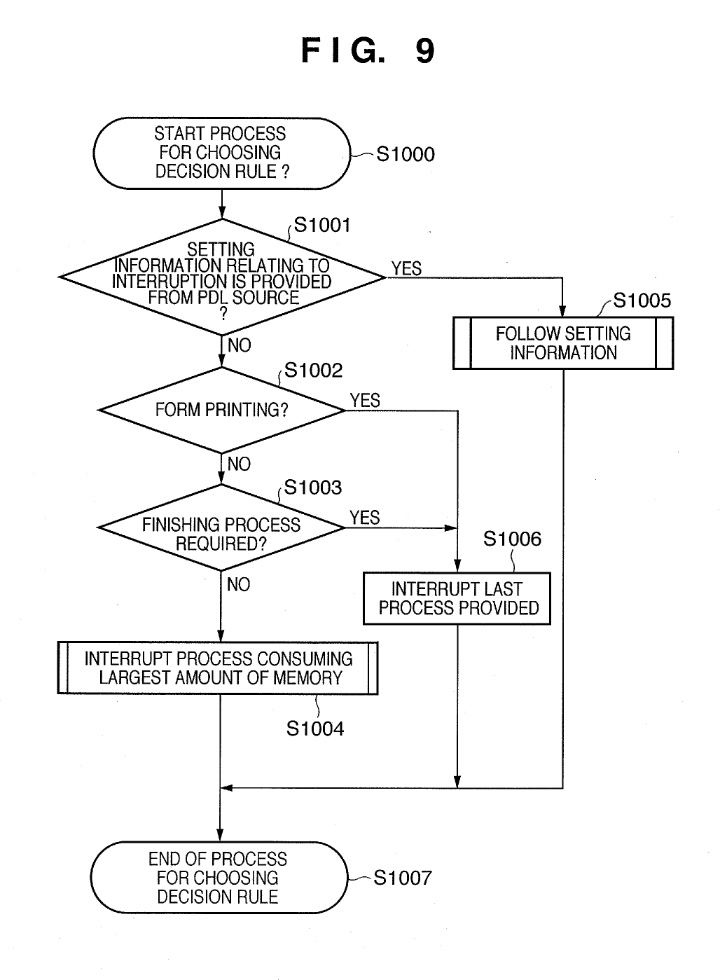

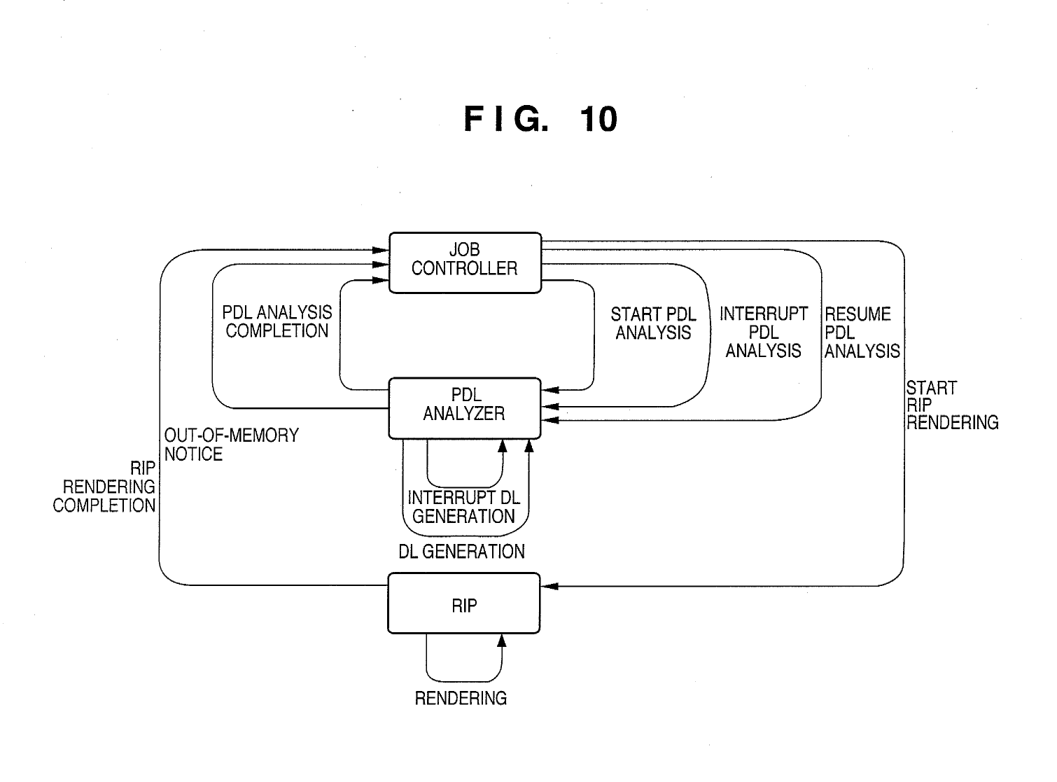

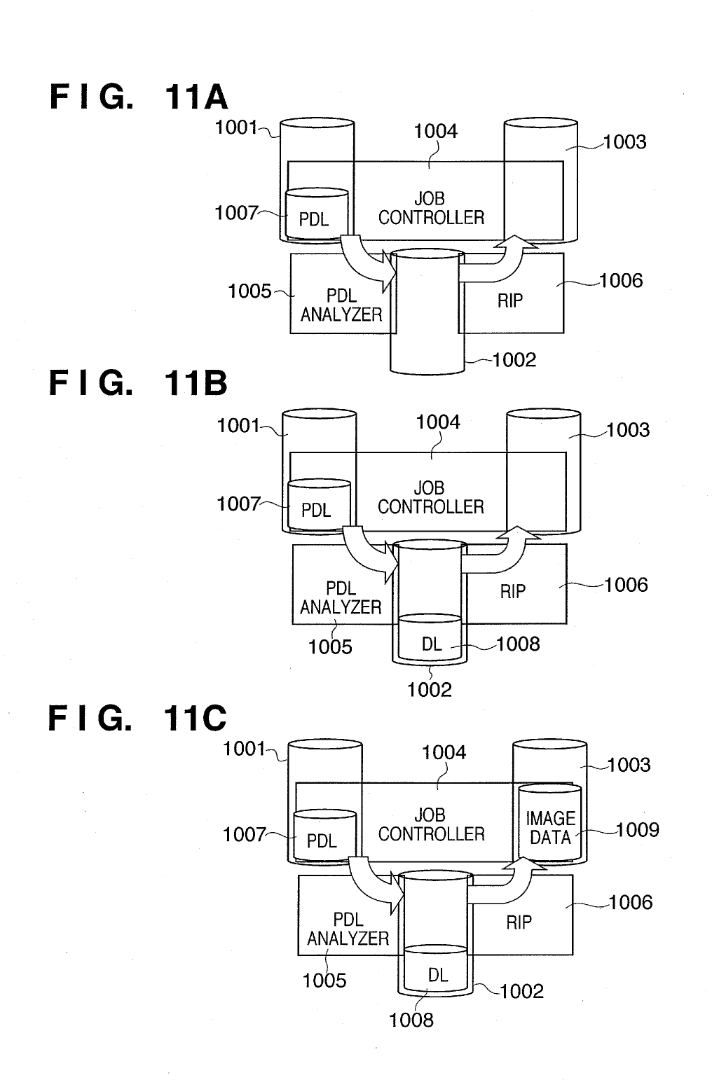

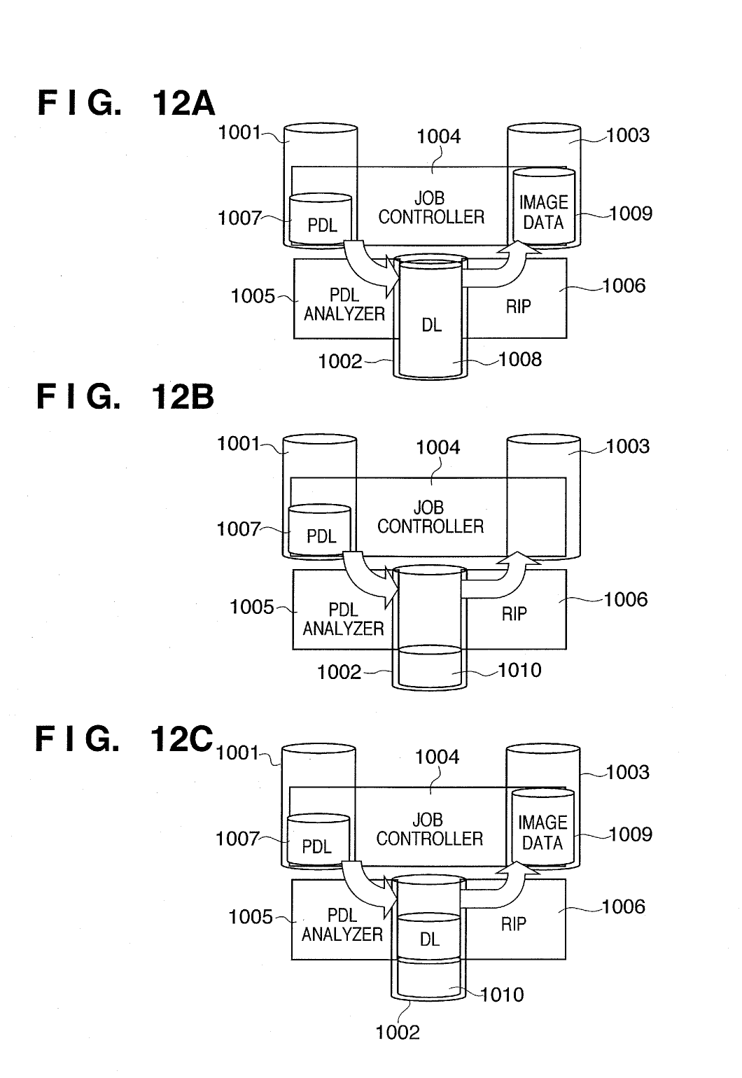

Referring to FIGS. 7A to 7F and FIG. 8, a process sequence according to the exemplary embodiment will be described with respect to an example in which fallback occurs while multitasking as described above is enabled.

FIGS. 7A to 7F are diagrams illustrating a flow of data in a case that PDL analyzing processing is implemented by multitasking according to the present exemplary embodiment.

FIG. 8 is a diagram illustrating a process performed by the job controller, PDL analyzers, and a raster image processor according to the present exemplary embodiment. In FIG. 8, common process with those in FIG. 6 is shown using the same reference numerals as in FIG. 6.

When multitasking is enabled, pieces of PDL data 1007a and 1007b input from the data processing apparatus 101 through the host interface 302 are first received by the job controller 2004. More than two pieces of PDL data 1007a and 1007b can be sent at a time. It is assumed here that before completion of generation of a DL 1008a by analysis of one piece of the PDL data 1007a, analysis of the next piece of the PDL data 1007b is started to generate a DL 1008b (FIG. 7B).

That is, the job controller 2004 adds information required for PDL processing in the PDL analyzers 2005a and 2005b to the pieces of the PDL data 1007a and 1007b based on information received from the data processing apparatus 101 and setting information stored in the printer 102. The job controller 2004 sends the PDL data to the PDL analyzers 2005a and 2005b and issues a PDL analysis start command (1101a and 1101b of FIG. 8). Here, the job controller 2004 issues the PDL analysis start command (1101b) to the PDL analyzer 2005b to start processing of the next PDL data 1007b before receiving a completion notice (1103a) of the previously started processing of the PDL data 1007a from the PDL analyzer 2005a.

In response to the command from the job controller 2004, the two PDL analyzers 2005a and 2005b starts analyzing process of the PDL data 1007a and 1007b, respectively, and generate intermediate language DLs 1008a and 1008b, respectively (1102a and 1102b in FIG. 8). Then, the PDL analyzers 2005a and 2005b respectively store these intermediate language DLs 1008a and 1008b in a memory area 1002 on the RAM 307, as shown in FIG. 7B.

As has been stated earlier, the capacity of the memory area 1002 on the RAM 307 for storing the intermediate language is limited whereas the sizes of PDL data 1007a and 1007b are not limited. Accordingly, the data sizes of DLs 1008a and 1008b generated from the PDL data 1007a and 1007b can exceed the capacity of the memory area 1002. Furthermore, as the DLs 1008a and 1008b become complicated and the data sizes of the DLs 1008a and 1008b increase, the RIP 2006 that renders the DLs 1001a and 1008b uses a larger amount of work area. Consequently, the memory space of the area 1002 for storing the DLs 1008a and 1008b can run out.

It will be understood that, given that the capacity of the memory area 1002 is fixed, the memory area 1002 is more likely to run out in a case where different types of intermediate data are concurrently generated than in a case where pieces of intermediate data of the same type are concurrently generated. Conventional-art solution to this problem has been to perform fallback if the memory area 1002 runs out. However, the fallback has the drawback described earlier.

A method for addressing an out-of-memory condition of the memory area 1002 for storing DLs (1008a, 1008b) without performing fallback will be described in the exemplary embodiment.

In FIG. 8, the memory area 1002 used for DL generation processing (1102a and 1102b) by the two PDL analyzers 2005a and 2005b runs out (1200) during the processing. Each PDL analyzer notifies the job controller 2004 of the out-of-memory condition (1121a or 1121b).

The job controller 2004 receives the out-of-memory notice (1121a or 1121b) and recognizes that the out-of-memory condition has occurred during DL processing in the PDL analyzer 2005a and/or 2005b. The job controller 2004 then determines which of the PDL analyzers should be caused to discontinue the DL processing. Discontinuing process (interruption unit) which chooses a PDL analyzer to cause it to discontinue processing will be described later.

In the example in FIG. 8, the job controller 2004 issues a PDL analysis stop command to the PDL analyzer 2005b (1122) in order to cause the PDL analyzer 2005b to interrupt the PDL analysis. Upon reception of the PDL analysis stop command from the job controller 204, the PDL analyzer 2005b interrupts the process of generating the DL (1123). As a result, all or part of the memory area 1002 on the RAM 307 used for generating the DL 1008b by the PDL analyzer 2005b is released.

The job controller 2004 then reallocates the memory area 1002 on the RAM 307 by using the released memory area for the DL generation processing performed by the PDL analyzer 2005a that has become unable to continue the processing due to the out-of-memory condition of the memory area 1002. The job controller 2004 issues a PDL analysis restart command to the PDL analyzer 2005a (1124a) In response to this command, the PDL analyzer 2005a resumes the DL generation processing (1102a) by using the area 1002 reallocated by the job controller 2004. As a result, the DL 1008a generated by the PDL analyzer 2005a is stored in the area 1002 as shown in FIG. 7C.

After the completion of the generation of the DL 1008a, the PDL analyzer 2005a sends a PDL analysis completion notice to the job controller 2004 (1103a). Upon reception of the PDL analysis completion notice, the job controller 2004 issues a rasterize start command (1111a) to the RIP 2006 to instruct it to start rendering of the DL 1008a. Consequently, the RIP 2006 starts rendering of the DL 1008a, and raster image data 1009a generated by the rendering is stored in the memory area 1003 as shown in FIG. 7D.

From the PDL analysis completion notice from the PDL analyzer 2005a, the job controller 2004 determines that the memory area 1002 occupied by DL generation by the PDL analyzer 2005a can be released. The job controller 2004 then reallocates the released space of the memory area 1002 for DL generation by the PDL analyzer 2005b. After the memory area is reallocated, the job controller 2004 issues a PDL analysis restart command to the PDL analyzer 2005b (1124b). In response to this command, the PDL analyzer 2005b resumes DL generation (1125) by using the reallocated memory space of the memory area 1002. As a result, the DL (1008b) generated by the PDL analyzer 2005b is stored in the memory area 1002 as shown in FIG. 7E.

After completion of DL generation by the PDL analyzer 2005b, the PDL analyzer 2005b issues a PDL analysis completion notice to the job controller 2004 (1103b). If a rendering completion notice has been provided from the RIP 2006 (1113a) at 1103b, the job controller 2004 instructs (1111b) the RIP 2006 to start rendering of the DL 1008b generated by the PDL analyzer 2005b. On the other hand, if the rendering completion notice has not been provided from the RIP 2006 at 1103b, the job controller 2004 waits for the rendering completion notice and then instructs the RIP 2006 to start rendering of the DL. Thus, rendering by the RIP 2006 is started, and raster image data 1009b generated by the rendering is stored in the memory area 1003 as shown in FIG. 7F. When the rendering process by the RIP 2006 is completed, the RIP 2006 notifies the job controller 2004 of completion of the rendering process (1113b), the rendering process ends.

After completion of the rendering process by the RIP 2006, the job controller 2004 outputs the raster image data loaded in the image memory 305 to the printer engine 105 through the engine interface 306. Thus, an image is formed by the printer engine 105.

A process performed by the job controller 2004 for deciding which PDL analyzer should be caused to interrupt processing in a case where an out-of-memory condition arises will be described next.

In the present exemplary embodiment, the following multiple decision rules are provided.

(A) The job controller 2004 interrupts the PDL analysis process performed in the PDL analyzer to which the start command for starting the PDL analysis has been most lately issued among multiple PDL analyzers performing processes relating to multiple pieces of PDL data.

(B) The job controller 2004 interrupts the PDL analysis process performed in the PDL analyzer that is making the slowest progress for DL generation among the multiple PDL analyzers performing processes relating to multiple pieces of PDL data.

(C) The job controller 2004 interrupts the PDL analysis process performed in the PDL analyzer that is using the largest amount of memory area for the PDL analysis process among the multiple PDL analyzers performing processes relating to multiple pieces of PDL data.

Among these decision rules, the decision rule (A) interrupts the last started DL generation process in favor of the process that is likely to be in the most advanced state among multiple DL generation processes being executed. Accordingly, the order in which printing of images based on multiple pieces of PDL data can be made the same as the order in which the job controller 2004 received data.

Decision rule (B) allows the PDL analyzer whose DL generation process is in a more advanced state to continue the process. The progress of a DL generation process can be estimated by determining that the DL generation process that has generated the DL having the smallest volume among the already generated multiple DLs is the DL generation process in the least advanced state.

Decision rule (C) can avoid occurring of an out-of-memory condition more reliably by releasing the largest amount of memory area. While multitasking is enabled, multiple PDL processes can be executed in parallel. Therefore, in order to more reliably avoid occurring of an out-of-memory condition of the memory area 1002, it is effective to interrupt the process that is consuming the largest amount of the memory area 1002.

FIG. 9 is a flowchart explaining a process performed by the job controller 2004 according to an exemplary embodiment of the present invention to determine which of the decision rules described above is to be used to choose a PDL analyzer to interrupt the PDL processing.

First, setting information of a process relating to information input from the data processing apparatus 101 described above through the host interface 302 and to PDL data 1007a and 1007b is read. Then, it is determined in step S1001 which of the three rules described above is to be used to choose a PDL analyzer that should be caused to interrupt processing. If setting information is available, the process proceeds to step S1005, where one of the three rules is selected based on the setting information and the selected rule is used to choose a PDL analyzer to interrupt the PDL processing.

On the other hand, if setting information is not provided in step S1001, the process proceeds to step S1002, it is determined based on the information from the data processing apparatus 101 and the PDL data whether or not a form printing is to be performed. If the form printing is to be performed, the process proceeds to step S1006 and the decision rule (A) is selected and applied. According to this rule, the order in which printing of images based on multiple pieces of PDL data is completed can be made the same as the order in which the job controller 2004 received the PDL data. This is effective in the form printing because the order in which images are printed is important in the form printing in general.

On the other hand, if it is determined in step S1002 that the form printing is not to be performed, the process proceeds to step S1003, it is determined based on the information from the data processing apparatus 101 and the PDL data whether a finishing process is required. If the finishing process is required, the process proceeds to step S1006 and the decision rule (A) is selected and applied. Thus, the order in which printing of images based on multiple pieces of PDL data is completed can be made the same as the order in which the job controller 2004 received the PDL data. The process is effective in the finishing process because it is often required in the finishing processes to maintain the order in which images are printed as those of input images.

On the other hand, if the finishing process is not required in step S1003, the process proceeds to step S1004, where the decision rule (C) is selected and applied. With this rule (c), the DL generation process that is consuming the largest amount of memory area is interrupted. Thus, an out-of-memory condition that arises during multiple DL generation tasks can be more reliably resolved.

As has been described, according to the present exemplary embodiment, the fallback which would otherwise occur due to an insufficient resource such as memory can be avoided to prevent reduction in the efficiency of PDL analysis. Thus, images can be printed more quickly.

By interrupting the DL generation performed by one of multiple analyzers as described above, a resource such as memory occupied by that DL generation can be released. Then, by reallocating the released resource to the other PDL analyzer, exhaustion of resources such as memory can be avoided and images can be printed.

Furthermore, according to the present exemplary embodiment, multitasking commensurate with hardware including multiple CPU cores can be implemented and therefore images with a higher quality can be printed.

It will be apparent to those skilled in the art that the spirit and scope of the present invention are not limited to the specific description herein but includes other exemplary embodiments, which will be described below.

### Exemplary embodiment 1

If DL generation in a PDL analyzer is interrupted, the DL generated up to that point in time may be deleted from the memory area 1002 and information about processing of the PDL data at the interrupted time may be held by the job controller 2004. The information about processing of the PDL data at the time when the processing was interrupted held by the job controller 2004 may be read and provided to the PDL analyzer so that the interrupted processing by the PDL analyzer is resumed.

Thus, the efficiency of PDL analysis processing of the PDL data resumed in the PDL analyzer can be increased.

### Exemplary embodiment 2

In a case that DL generation in a PDL analyzer is to be interrupted, the DL generated by the PDL analyzer may be stored in an external storage (for example a hard disk) and then the DL may be deleted from the memory area 1002. When the interrupted processing is resumed, the DL stored in the external storage may be read out and used.

Thus, the DL stored when the processing was interrupted can be restored and the PDL analysis can be continued using the stored DL. Therefore, the processing speed can be increased by effectively using the DL generated in the previous processing.

### Exemplary embodiment 3

When DL generation in a PDL analyzer is to be interrupted, the DL generated by the PDL analyzer may be compressed and a part of the memory area 1002 may be released. When the interrupted process is resumed, the compressed DL may be decompressed and loaded in the memory area 1002.

Thus, information at the time when the processing was interrupted can be restored and the PDL processing can be resumed. Therefore, the exemplary embodiment has the effect that the PDL processing can be quickly resumed.

### Other embodiments

The exemplary embodiments of present invention has been described in detail. The present invention can be applied to a system consisting of multiple devices or an apparatus formed by a single device.

The present invention can also be achieved by providing a program that implements the functions of any of the exemplary embodiments described above directly or remotely to a system or an apparatus to allow a computer of the system or apparatus to read and execute the program provided. In that case, the program may be in any form capable of functioning as a program. The implementation does not necessarily need to be a program, provided that it has functionality equivalent to a program.

Therefore, a program code itself installed in a computer in order to implement the functions and processes of the present invention also implements the present invention. That is, the program code itself for implementing the functions and processes of the present invention is also included in the claims of the present invention. The program may be in any form that has functionality of a program, such as an object code, a program executed by an interpreter, or script data to be provided to an OS.

The recording medium for providing the program may be of any of various types. Examples include a Floppy® disk, hard disk, optical disk, magneto-optical disk, MO, CD-ROM, CD-R, CD-RW, magnetic tape, non-volatile memory card, ROM, and DVD (DVD-ROM and DVD-R).

Alternatively, a browser of a client computer may be used to access a Web page on the Internet to download a program of the present invention to a recording medium such as a hard disk. The downloaded program may be the computer program of the present invention or a file containing the compressed computer program and an automatic installing function. Furthermore, the program code constituting the program of the present invention may be divided into files. The files may be downloaded from different Web pages. In other words, the claims of present invention also include a WWW server from which multiple users can download a program file that implements the functions and processing of the present invention on computers.

The program according to the present invention can be encrypted, stored on a storage medium such as a CD-ROM and delivered to a user. Users who meet predetermined requirements may be allowed to download key information for decrypting the program from a Web page through the Internet, and then the users may use the key information to install the encrypted program in an executable form on a computer.

The present invention can also be implemented in a form other than the form in which a computer reads and executes a program to implement functions of any of the embodiments described above. For example, an OS running on a computer can perform part or all of actual processing based on the instruction of the program and the processing can implement functions of any of the embodiments described above.

The program read from a recording medium may be written in a memory provided in a function extension board inserted into a computer or a function extension unit attached to a computer and a CPU provided in the function extension board or unit can execute all or part of actual processing based on the instruction of the program, and the function can implement the functions of any of the embodiments described above.

While two PDL analyzers are used in the exemplary embodiments described above, the present invention can be applied to an apparatus that includes three or more PDL analyzers. In such a case, more than one PDL analyzers will resume PDL analysis and therefore resources should be allocated to those multiple PDL analyzers and a PDL analysis restart command should be issued to the PDL analyzers.

While multiple PDL analyzers and a single RIP are provided in the present exemplary embodiments, multiple RIPs that function as drawing means may be provided, of course.

Preferably, dedicated hardware (CPU core) is provided for each PDL analyzer and RIP in a printer according to the present exemplary embodiment.

The present invention is not limited to a printer. The present invention can be applied to a device driver that is installed in an apparatus such as a personal computer and provides image data from image data created in an application program to a printer or a display.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2006-333866, filed Dec. 11, 2006, which is hereby incorporated by reference herein in its entirety.

What is claimed is:

1. A print control apparatus comprising:
an input unit configured to input page description language data;
a plurality of drawing units, each of which configured to perform a processing for analyzing the page description language data input by said input unit to generate image data;
a control unit configured to control resource allocation to said plurality of drawing units and parallel processing performed by said plurality of drawing units; and
an interruption unit configured to interrupt a processing performed by a first drawing unit of said plurality of drawing units that are performing the parallel processing in a case where an out-of-resource condition occurs in any of said drawing units during the parallel processing;
wherein said control unit, in response to that said interruption unit interrupts the processing performed by the first drawing unit, releases a resource associated with an interrupted processing and allocates released resource to another drawing unit to allow the another drawing unit to continue processing.

2. The print control apparatus according to claim 1, wherein the first drawing unit is a drawing unit that most lately starts the processing among said plurality of drawing units.

3. The print control apparatus according to claim 1, wherein said first drawing unit is a drawing unit that is analyzing the page description language data at the lowest speed among said plurality of drawing units.

4. The print control apparatus according to claim 1, wherein said first drawing unit is a drawing unit that uses the largest amount of resource among said plurality of drawing units.

5. The print control apparatus according to claim 1, the resource is memory that stores a drawing object generated by each of the plurality of drawing units.

6. A control method of a print control apparatus for performing a process for converting page description language data into image data in a multitasking manner, the method comprising the steps of:
inputting page description language data;
controlling resource allocation to a plurality of drawing tasks each of which analyzes page description language data input in said inputting step to generate image data and parallel processing performed by the plurality of drawing tasks; and
interrupting a processing performed by a first drawing task of the plurality of drawing tasks that are performing the parallel processing in a case where an out-of-resource condition occurs in any of the drawing tasks during the parallel processing;
wherein in said controlling step, in response to that the interrupting a processing performed by the first drawing task, a resource associated with the interrupted processing is released and the released resource is allocated to another drawing task to allow the another drawing task to continue processing.

7. The control method according to claim 6, wherein the first drawing task is a drawing task that most lately starts processing among the plurality of drawing tasks.

8. The control method according to claim 6, wherein the first drawing task is a drawing task that is analyzing the page description language data at the lowest speed among the plurality of drawing tasks.

9. The control method according to claim 6, wherein the first drawing task is a drawing task that uses the largest amount of resource among the plurality of drawing tasks.

10. A device driver for performing a process for converting page description language data into image data in a multitasking manner, the device comprising:
an input unit configured to input page description language data;
a plurality of drawing units each of which configured to analyze the page description language data input by said input unit to generate image data;
a control unit configured to control resource allocation to said plurality of drawing units and parallel processing performed by said plurality of drawing units; and
an interruption unit configured to interrupt a processing performed by a first drawing unit of said plurality of drawing units that are performing the parallel processing in a case where an out-of-resource condition occurs in any of said drawing units during the parallel processing;
wherein said control unit, in response to that said interruption unit interrupts the processing performed by the first drawing unit, releases a resource associated with interrupted processing and allocates released resource to another drawing unit to allow the another drawing unit to continue processing.

11. The device driver according to claim 10, wherein the first drawing unit is a drawing unit that most lately starts processing among said plurality of drawing units.

12. The device driver according to claim 10, wherein the first drawing unit is a drawing unit that is analyzing the page description language data at the lowest speed among said plurality of drawing units.

13. The device driver according to claim 10, wherein the first drawing unit is a drawing unit that uses the largest amount of resource among said plurality of drawing units.
